(19) United States
(12) Patent Application Publication
(10) Pub. No.: US 2011/0274942 A1
(43) Pub. Date: Nov. 10, 2011

(54) CORROSION RESISTANT ALUMINUM FOAM PRODUCTS

(75) Inventors: J. Daniel Bryant, Murrysville, PA (US); David F. Iwig, Greensburg, PA (US)

(73) Assignee: Alcoa Inc.

(21) Appl. No.: 13/007,010

(22) Filed: Jan. 14, 2011

Related U.S. Application Data
(60) Provisional application No. 61/323,552, filed on Apr. 13, 2010.

(51) Int. Cl. B32B 5/18; C22B 21/00

(52) U.S. Cl. 428/613; 75/415; 266/217

(57) ABSTRACT

An aluminum foam product that exhibits superior resistance to corrosion and oxidation in aqueous environments. The invention comprises the incorporation of chemical buffering agents, such as anhydrous borax (Na₂B₄O₇), into the formulation of aluminum foam in amounts that effectively reduce the corrosion and oxidation in aqueous environments.

### CROSS-REFERENCE TO RELATED APPLICATIONS

This nonprovisional patent application claims priority to U.S. Provisional Patent Application Ser. No. 61/323,552, filed with the United States Patent and Trademark Office on Apr. 13, 2010 and herein incorporated by reference in its entirety for all purposes. This nonprovisional patent application is additionally related to U.S. Pat. No. 7,452,402 and its continuation application, U.S. Nonprovisional patent application Ser. No. 12/248,708, the disclosures of each of which are incorporated by reference in their entirety for all purposes.

### STATEMENT REGARDING FEDERALLY-SPONSORED RESEARCH OR DEVELOPMENT

Not Applicable

### THE NAMES OF THE PARTIES TO A JOINT RESEARCH AGREEMENT

Not Applicable

### REFERENCE TO A SEQUENCE LISTING

Not Applicable

### BACKGROUND OF THE INVENTION

Low-density aluminum foam offers an attractive combination of physical and mechanical attributes and is being considered in a variety of applications. The high rigidity of aluminum foam, compared to other low density products such as polymer foams or wood products, makes the material particularly well suited for structural applications. The fire and smoke resistance of aluminum foam, combined with their high recycle content, has made aluminum foam panels well suited for many applications in the building and architectural fields, both as monolithic panels and as the core for laminated products in outdoor applications.

A key feature of producing aluminum foam for use in thin panel applications, however, is the creation of a highly refined cell structure. Cell sizes must be kept small, preferably a fraction of the product thickness, if the material is to exhibit uniform and predictable mechanical properties. To maintain low density at such small cell sizes the foam must have thin cell walls. As a consequence of these two structural parameters, small cell size and thin cell walls, the interior surface area of such an aluminum foam can be quite large, much as it is for metal powder compacts. Given the large surface area of aluminum foam, consideration must be given to the effects of surface oxidation and corrosion. While monolithic aluminum plate and porous aluminum foam may be subject to similar mechanisms of surface attack in certain environments, the exposed surface area per weight in an aluminum foam may be several orders of magnitude greater than that of its monolithic counterpart, and thus the effects of minor surface corrosion can be greatly amplified.

The resistance of aluminum to corrosion and oxidation in aqueous environments is affected by temperature, pressure, alloying additions and the chemistry of the water itself. The protective oxide layer on aluminum, corundum (Al₂O₃), undergoes a series of transformations to various forms of aluminum hydroxide, including bayerite (α-Al(OH)₃), gibbsite (γ-Al(OH)₃), boehmite (γ-AlOOH) and others in contact with water. The chemistry and character of these transformations is very much dependent of the nature of the aqueous environment, particularly the temperature and the pH. Though the surface reaction that creates these aluminum hydroxide phases is generally self limiting and only affects the oxide to a depth of several microns, the solubility of these phases in aqueous environments can have a significant effect on the stability of the underlying metal. The equilibrium solubility of gibbsite (γ-Al(OH)₃) in water increases by four orders of magnitude when the hydrogen ion concentration of the water is lowered from a pH of 7 (neutral) to a pH of 4 (a mild acid). Similar effects are noted on the alkaline side of the pH scale. The solubility of gibbsite increases by a similar factor if the pH is raised to a value of 10 (a mild base). The dissolution of the protective film of aluminum hydroxide results in the creation of new layers of aluminum hydroxide, which results in a loss of the underlying metal. Chemically, this creation of aluminum hydroxide from aluminum can be described by the equation:

Al+3H₂O [symbol] 3/2H₂+Al(OH)₃ (1)

At ambient temperatures of 20° C., this reaction results in the liberation of 427 kJ of heat per mole and the production of hydrogen gas (“outgassing”). Consequently, either heat generation or hydrogen gas evolution can be used to monitor the rate of aluminum hydroxide formation and hence the corrosion of the aluminum through this reaction.

Chemical analysis of aluminum foam produced through the decomposition of carbonates (U.S. Pat. No. 7,452,402, the disclosure of which is hereby incorporated by reference in its entirety, for all purposes) has shown that the alkaline oxides produced in the manufacturing process can affect the rate of surface aluminum hydroxide formation when the aluminum foam product is subjected to aqueous environments. The decomposition of calcium carbonate (CaCO₃) within a molten aluminum-magnesium alloy results in the following cascade of chemical reactions:

CaCO₃→CaO+CO₂ (2)

CO₂+Al→Al₂O₃+CO (3)

CaO+Al→AlCaOₓ (4)

CO₂+Mg→MgO+CO (5)

Chemical analysis has confirmed the presence of small quantities of both calcium oxide (calcia, or CaO) and magnesium oxide (magnesia, or MgO) as by-products of the aluminum foam-producing decomposition reaction. A fraction of these fine particulates are deposited on the surface of the bubble cells. While normally inert in contact with aluminum, the ingress of water from the surface into the structure results in a conversion of these oxides to hydroxides, specifically, Ca(OH)₂ and Mg(OH)₂.

In equilibrium, the solubility of Ca(OH)₂ in H₂O approaches 2 grams per liter. This saturated solution (lime water) is caustic with a pH of 12 to 12.5. Likewise, the solubility of Mg(OH)₂ in water approaches 0.02 grams per liter. This saturated solution (milk of magnesia) is also caustic, with a pH of 10 to 10.2.

In conditions of saturated, non-moving water ingress, the local pH within the bubble cells can rise due to the dissolution hydration of the CaO and MgO oxides. As noted, in aqueous environments, the aluminum oxide film which protects the aluminum foam converts to aluminum hydroxide. In caustic environments, specifically in aqueous environments with pH values above 11, the solubility of aluminum hydroxide rises significantly. As a result, the layer of aluminum hydroxide is stripped from the surface, resulting in a corrosive attack and the conversion of aluminum into aluminum hydroxide and the associated generation of hydrogen gas.

While the reaction is self-limiting, the high surface area of aluminum foam results in a significant outgassing of hydrogen gas, and in the early stages of wetting, a significant release of heat. This reaction has raised concerns with respect to the adherence of paint and adhesives in the event of undercutting by moisture.

### BRIEF DESCRIPTION OF THE DRAWINGS

A full understanding of the invention can be gained from the following description of the preferred embodiments when read in conjunction with the accompanying drawings in which:

FIG. 1 shows the rate of hydrogen gas generation by an aluminum foam sample prepared without anhydrous borax when immersed in water for a period of one hundred hours.

FIG. 2 shows the total volume of hydrogen gas generated by an aluminum foam sample prepared without anhydrous borax when immersed in water for a period of one hundred hours.

FIG. 3 is a graph of the hydrogen gas generation rate by aluminum foam samples fabricated using four different loadings of anhydrous borax when immersed in water for a period of 100 hours.

FIG. 4 is a graph of the total volume of hydrogen gas produced by aluminum foam samples with four different loadings of anhydrous borax when immersed in water for a period of 100 hours.

FIG. 5 is a graph of the hydrogen gas generation rate by aluminum foam samples (“Foam B”) manufactured with a 1.0 wt % loading of anhydrous borax when immersed in water for a period of 48 hours and a comparable hydrogen gas generation rate of an aluminum foam that does not contain the anhydrous borax addition (“Foam”).

FIG. 6 is a graph of the cumulative volume of hydrogen gas produced by an aluminum foam sample manufactured with a 1.0 wt % loading of anhydrous borax (“Foam B”) when immersed in water over a period of 48 hours along with the cumulative volume of hydrogen gas produced by an aluminum foam that does not contain the anhydrous borax addition (“Foam”).

FIG. 7 is a graph of the hydrogen gas generation rate by aluminum foam samples manufactured with a 1.0 wt % loading of anhydrous borax (“Foam B”) when wetted in water over a period of 48 hours and a comparable hydrogen gas generation rate of an aluminum foam that does not contain the anhydrous borax addition (“Foam”).

FIG. 8 is a graph of the cumulative volume of hydrogen gas produced by an aluminum foam sample manufactured with a 1.0 wt % loading of anhydrous borax (“Foam B”) when wetted in water over a period of 48 hours along with the cumulative volume of hydrogen gas produced by an aluminum foam that does not contain the anhydrous borax addition (“Foam”).

FIG. 9 is a scanning electron microscope image of anhydrous borax particles embedded on the cell walls of an aluminum foam sample.

FIG. 10 is a schematic diagram of an apparatus for incorporating Na₂B₄O₇ into the manufacture of aluminum foam by direct addition of gas forming particles and Na₂B₄O₇ into the molten metal stream.

FIG. 11 is a schematic diagram of an apparatus for incorporating Na₂B₄O₇ into the manufacture of aluminum foam by mixture addition.

FIG. 12 is a schematic diagram of an exposed section of aluminum foam bearing anhydrous borax particles on the surface of the foam cell walls.

### DETAILED DESCRIPTION OF THE INVENTION

For the purposes of describing and claiming the present invention, the following terms are defined:

The term “distributed” means a dispersion of one phase or material has been created within a matrix of a second phase or material.

The term “buffering agents” means a compound that dissociates in water to such an extent that it promotes the retention of a constant and consistent pH level, even when acids or bases are added to said water.

The term “sufficiently dispersed” with respect to buffering agents means a dispersion of buffering agent(s) within a first phase or compound, where the buffering agent(s) (i) are relatively uniformly distributed within the first phase or compound; and (ii) maintain substantial efficacy as buffering agent(s).

The term “wetted” means in contact with water for a period of time before removal to an air environment.

The term “immersed” means submerged in water and held in a submerged condition for a period of time.

The term “generated” means the production of gaseous byproducts from an oxidation reaction.

The invention disclosed herein provides for an aluminum foam product that is more resistant to the formation of aluminum hydroxide and hydrogen out-gassing under conditions of high moisture. The invention comprises the incorporation of buffering agents into the formulation of aluminum foam in amounts that effectively reduce the corrosion and oxidation in aqueous environments, in both wetting and long-term immersion environments.

In one embodiment, the present invention provides for an aluminum foam product comprising a distribution of pores, or cells, within a metal alloy comprising aluminum and a distribution of buffering agents on the cell wall surfaces. These buffering agents, when wetted by water ingress into the foam structure, promote a hydrogen ion concentration (or pH) within the local aqueous environment of the foam cells that suppresses corrosion and oxidation of the foam structure. Examples of effective particulate buffering agents are anhydrous borax (Na₂B₄O₇), boron oxide (B₂O₃) and boric acid (H₃BO₃).

In another embodiment, the present invention provides a method of making foamed aluminum that is resistant to corrosive attack. This method comprising the steps of adding gas producing particles, along with buffering agents, into a molten metal alloy comprising aluminum and agitating the mixture to produce a liquid metal foam with a distribution of pores, metallic oxide phases and buffering agents within its structure. This liquid metal foam is then solidified to yield a solid metal foam with a distribution of buffering agents adhering to the bubble cell walls that improve the corrosion resistance of the foam product.

In one embodiment of the present invention, the anhydrous borax particles are used as buffering agents.

In another embodiment of the present invention, a foamed aluminum product is provided comprising an aluminum alloy, a distribution of fine pores within the aluminum alloy, and an anhydrous borax particle component in a percentage ranging from about 0.25% to about 3% by weight percent of the aluminum alloy. In another embodiment, the distribution of anhydrous borax particles is in a percentage ranging from about 1% to about 3%. In another embodiment, the distribution of anhydrous borax particles is in a percentage ranging from about 0.50% to about 3%. In another embodiment, the distribution of anhydrous borax particles is in a percentage greater than 0.25%. In another embodiment, the anhydrous borax particle component is in a percentage adequate to result in a sufficient distribution of anhydrous borax particles within a first phase or compound.

In another embodiment of the present invention, boron oxide particles are used as the buffering agents.

In yet another embodiment of the present invention, boric acid particles are used as the buffering agents.

In one embodiment, a method is taught wherein the buffering agents are pre-mixed with the gas producing particles in an appropriate ratio and this mixture is added to the agitated molten metal.

In one embodiment, addition of the buffering agents to the foamed aluminum product results in a reduction of hydrogen outgassing of about 90% as compared to a foamed aluminum product lacking such buffering agents when both products are exposed to similar conditions (for example, wetting or immersion of the aluminum foam product(s)). In another embodiment, the reduction of hydrogen outgassing is about 95%. In another embodiment, the reduction of hydrogen outgassing is about 85%. In another embodiment, the reduction of hydrogen outgassing is about 80%. In another embodiment, the reduction of hydrogen outgassing is about 75%. In another embodiment, the reduction of hydrogen outgassing is about 70%. In another embodiment, the reduction of hydrogen outgassing is about 65%.

In another embodiment of the present invention, the buffering agents are metered into the molten metal alloy independently from the gas producing particles.

In yet another embodiment of the present invention, an apparatus is provided for practicing the above-described method. In its simplest implementation, the inventive apparatus requires only one vessel chamber for continuous production of a foamable molten alloy containing a dispersion of buffering agents. In broad terms, the inventive apparatus for producing a corrosion resistant foamed aluminum product comprises a feeding system for providing gas producing particles; a feeding system for providing buffering agents; a feeding system for providing molten metal alloy; a reactor in communication with the three feeding systems for combining the gas producing particles, the buffering agents and the molten metal alloy into a foamable suspension.

The foamed aluminum products made by the process of this invention exhibit superior resistance to corrosion in aqueous environments when compared to foam products without a sufficient dispersion of buffering agents.

In one embodiment, the present invention provides an aluminum foam product and a method for producing an aluminum foam product which contains particulate buffering agents, such as anhydrous borax (Na₂B₄O₇), dispersed within its structure. The method incorporates adding buffering agents, along with gas producing particles into a molten metal alloy, wherein at least a portion of the gas producing particles decompose to provide a foamable suspension of metal oxide, buffering agents and gas bubbles. The present invention also provides an apparatus for practicing the method of the present invention. The present invention is now discussed in more detail referring to the drawings that accompany the present application. In the accompanying drawings, like and/or corresponding elements are referred to by like reference numbers.

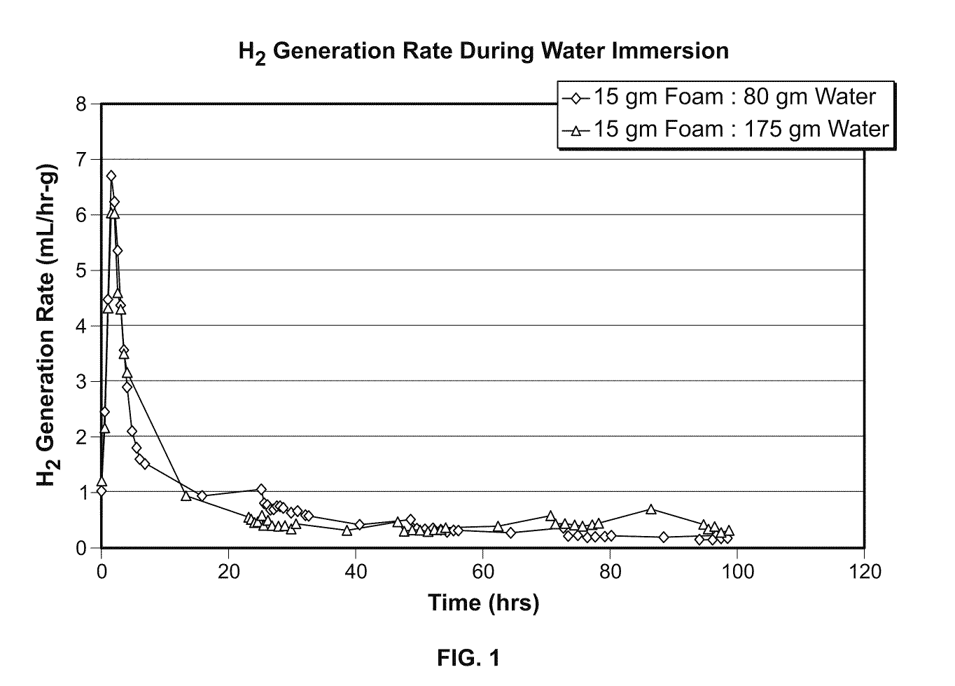

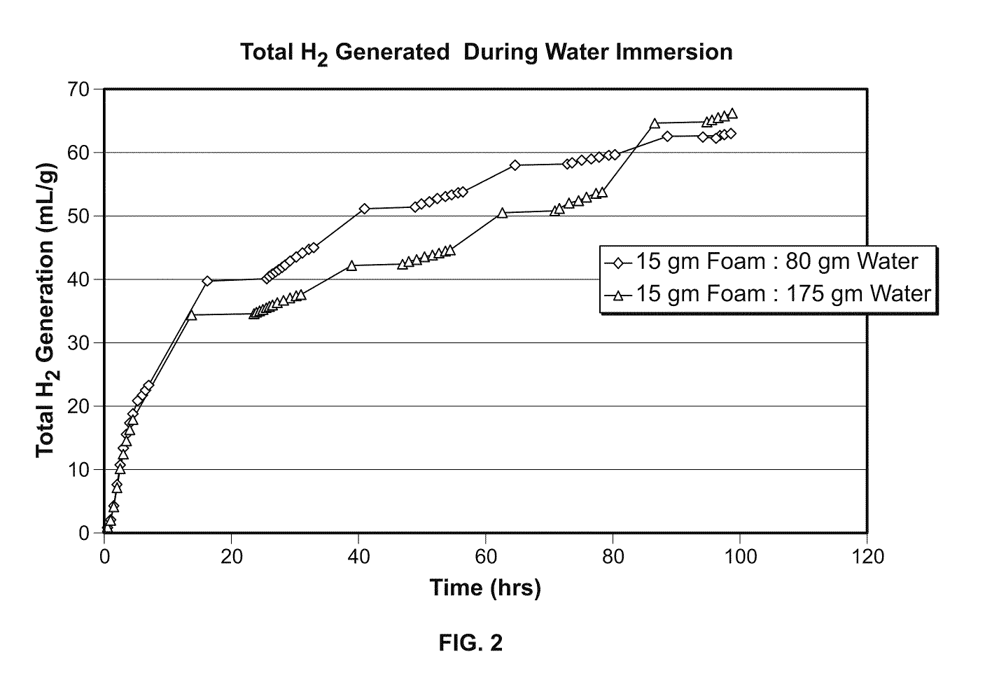

FIG. 1 shows the rate of hydrogen gas generation (“outgassing”) by an aluminum foam sample prepared without anhydrous borax when immersed in water for a period of one hundred hours. As can be seen in FIG. 1, following an initial period of slow reactivity, a peak in hydrogen gas evolution can be seen approximately two hours after the initial immersion. For samples that are fully exposed to water ingress, this hydrogen gas evolution rises to a value up to 6 ml per hour per gram of immersed material. Within 30 hours of this initial immersion, the hydrogen gas evolution (and the associated generation of heat) drops to roughly 10% of this initial value, and continues to decline, though a measurable outgassing can still be seen after 100 hours. The net production of hydrogen gas can be followed with the aid of FIG. 2. FIG. 2 shows the cumulative volume of hydrogen gas generated by an aluminum foam sample prepared without a sufficiently distributed buffering agent (e.g., anhydrous borax) when immersed in water for a period of one hundred hours. Though the hydrogen gas generation level can be seen to trail off owing to the passivation of the surface with time, over 60 ml per gram of hydrogen gas can be produced in such a fully immersed and exposed specimen. This outgassing, under the wrong conditions, could possibly compromise coatings on the foam.

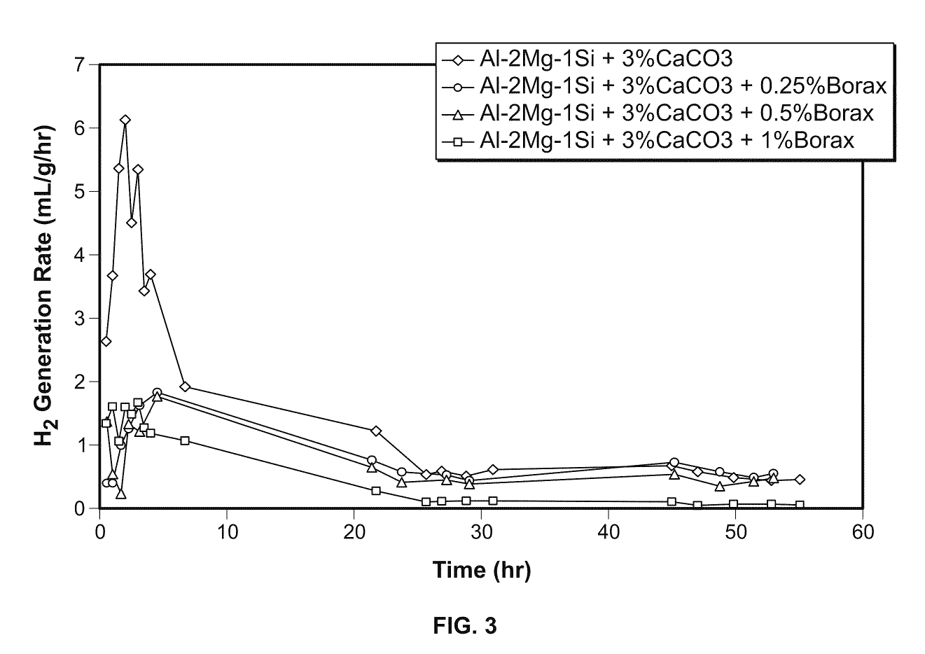

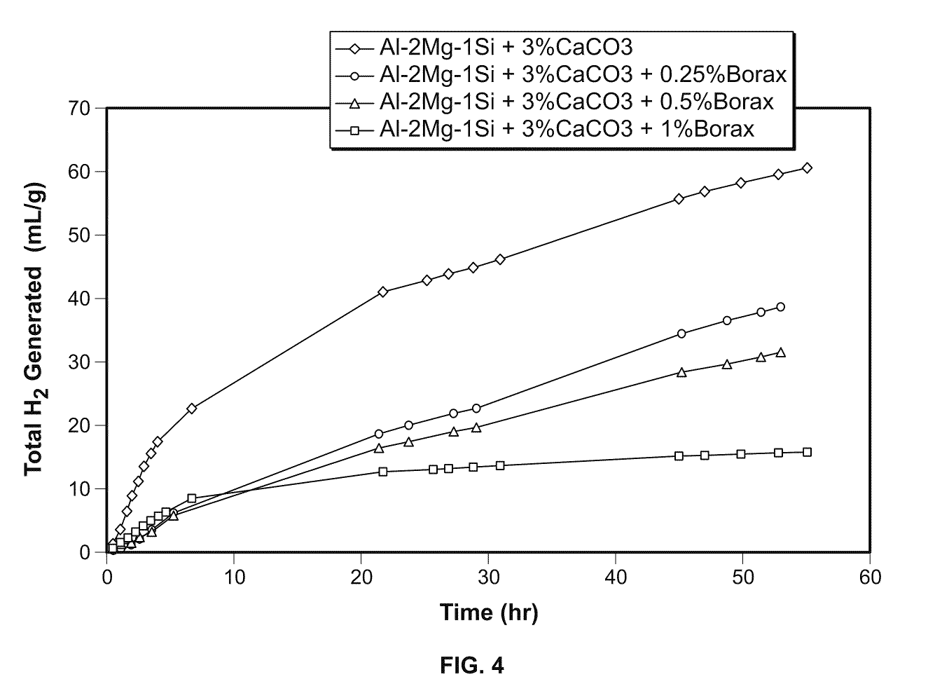

Incorporation of anhydrous borax into the structure of the aluminum foam acts to mitigate the creation of hydrogen gas. As anhydrous borax (Na₂B₄O₇) is a known chemical buffer when dissolved in water, the natural action of this compound can be used to control the local pH within the aluminum foam cells that have been infiltrated by water. Anhydrous borax undergoes partial dissolution to create a buffered solution of pH 9.2. This very mild alkaline environment is well within the stable pH range of aluminum hydroxide, acting to counter any effects of the more caustic hydroxides of calcium and magnesium that can be formed through the reaction of infiltrating water with the by-products of the foaming reaction in the product. As the melting point of anhydrous borax (741° C.) is above the melting point of the aluminum alloy or any temperature used in the manufacturing of the foam product, the particles can be added directly to the molten metal without concern for their melting or coalescing into a liquid mass. In FIG. 3, is a graph is shown of the hydrogen gas generation rate of four aluminum foam samples fabricated using four different loadings of anhydrous borax when immersed in water for a period of 100 hours. FIG. 4 show a comparable graph of the same four foam specimens, in this case showing the cumulative volume of hydrogen gas produced by the specimens. The two FIGs show an increasing efficacy in reducing both the rate of hydrogen gas generation and the total hydrogen gas generation with increasing Na₂B₄O₇ addition, over the range of 0 wt % to 1 w %. The maximum rate of hydrogen gas generation drops by a factor of 5 at a loading of 1 wt % and trails off to a level representing a 90% to 95% reduction after 100 hours.

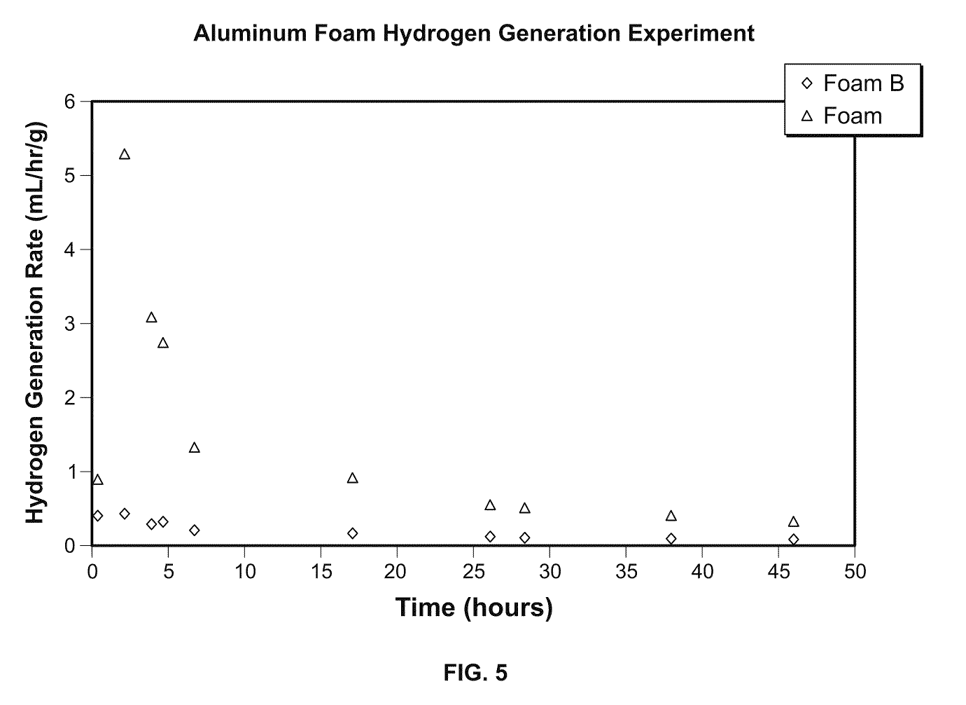

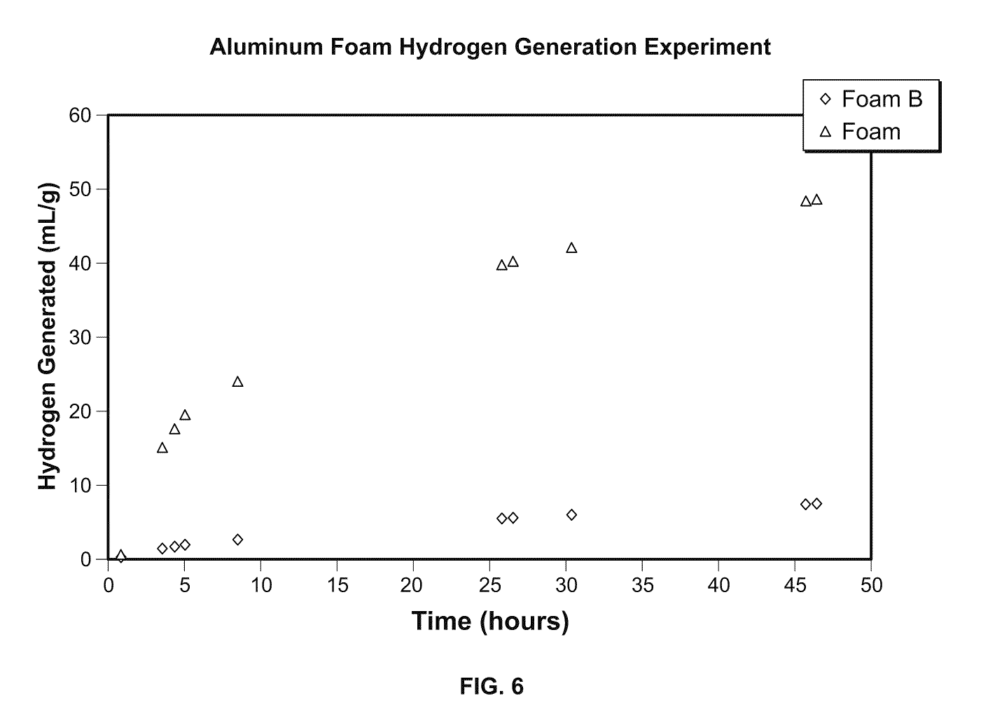

Under industrial manufacturing conditions, the identical efficacy is found. In FIG. 5 a graph of the hydrogen gas generation rate by aluminum foam samples manufactured with a 1.0 wt % loading of anhydrous borax is shown for the specimens fully immersed in water for a period of 55 hours. The hydrogen gas generation rates for an aluminum foam sample manufactured without the anhydrous borax addition is shown for comparison in the same graph. In FIG. 6 the accompanying graph of the cumulative volumes of hydrogen gas produced by the two specimens is provided.

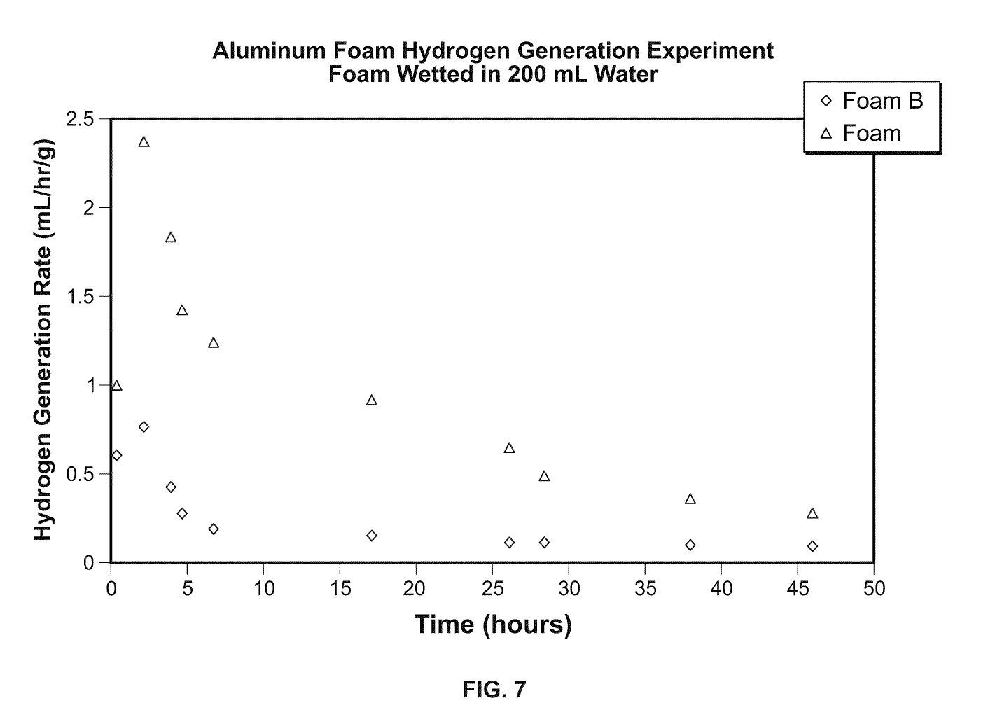

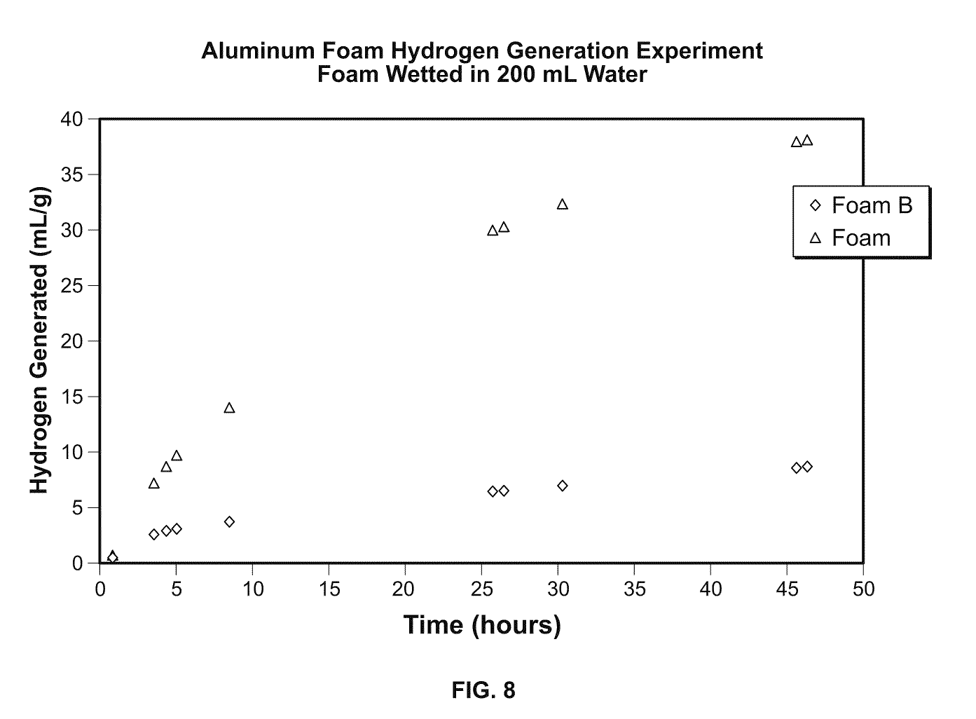

An alternative service condition, one of wetting (but not immersion) is shown in FIG. 7. Here, a graph of the hydrogen gas generation rate by aluminum foam samples manufactured with a 1.0 wt % loading of anhydrous borax when wetted in water over a period of 55 hours is provided, along with that of comparable sample of aluminum foam that does not contain the anhydrous borax addition. FIG. 8 is the associated graph of the cumulative volumes of hydrogen gas produced by the two specimens. As can be seen, the Na₂B₄O₇ addition is equally effective in this service scenario.

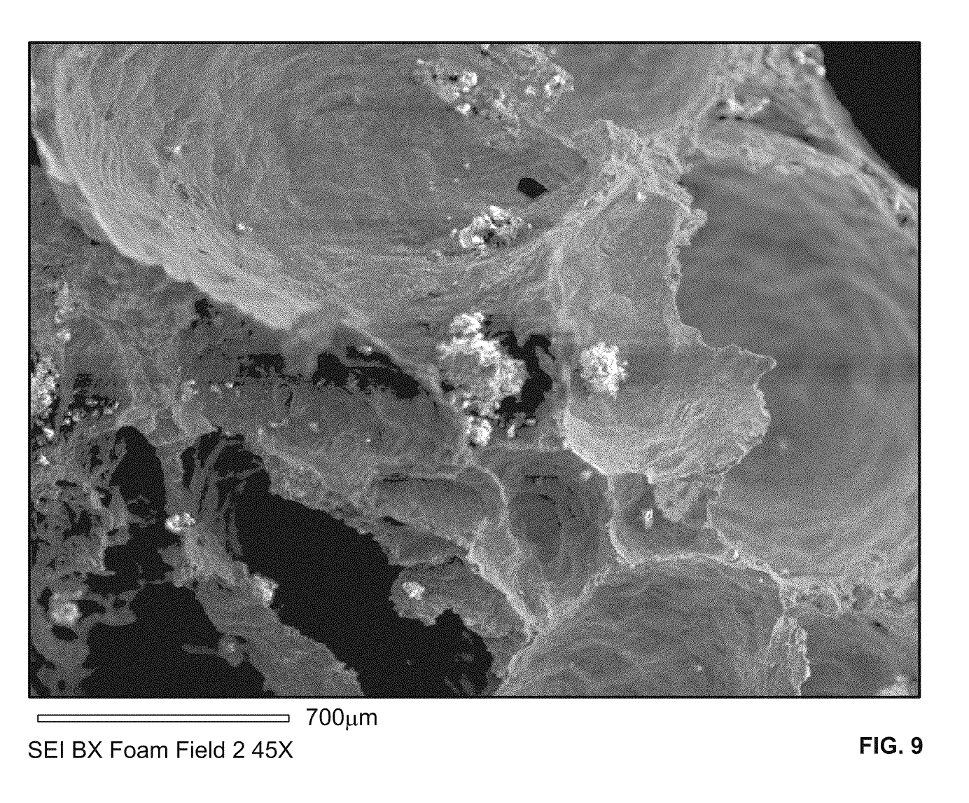

FIG. 9 shows a fractograph of a specimen of aluminum foam manufactured using the anhydrous borax formulation. Energy dispersive x-ray analysis (EDAX) was used to verify the identity of the particulate decorating the surface of the cell walls. The large globular particles were determined to be anhydrous borax. The particle size of 50 to 70 microns is comparable to the starting particle size for a −200 mesh product, indicating that the borax particles did not melt nor coalesce into a fully liquid phase within the reactor. Two additional observations were made regarding the appearance of the borax on the cell wall surfaces. Firstly, the particles appear more rounded or spherical than the faceted material that was examined prior to addition to the reactor. Secondly, the borax particles appear to be decorated with smaller, chemically distinct particles on their surface. EDAX indicates that most of these particles are CaO and MgO, both by-products of the foaming reaction. These observations suggest that the borax particles, while not melting, may develop a tacky surface within the reactor, onto which the foaming by-products (specifically CaO and MgO) may glom. As both CaO and MgO both dissociate in water to yield the caustic compounds CaOH and MgOH, the physical proximity of these compounds with particles of the buffering agent may act to ameliorate the rise in pH level. It is speculated that the attachment of the caustic oxides directly to the surface of the buffering agent (Na₂B₄O₇) may indeed account for some of the efficacy of the addition in reducing hydrogen gas generation.

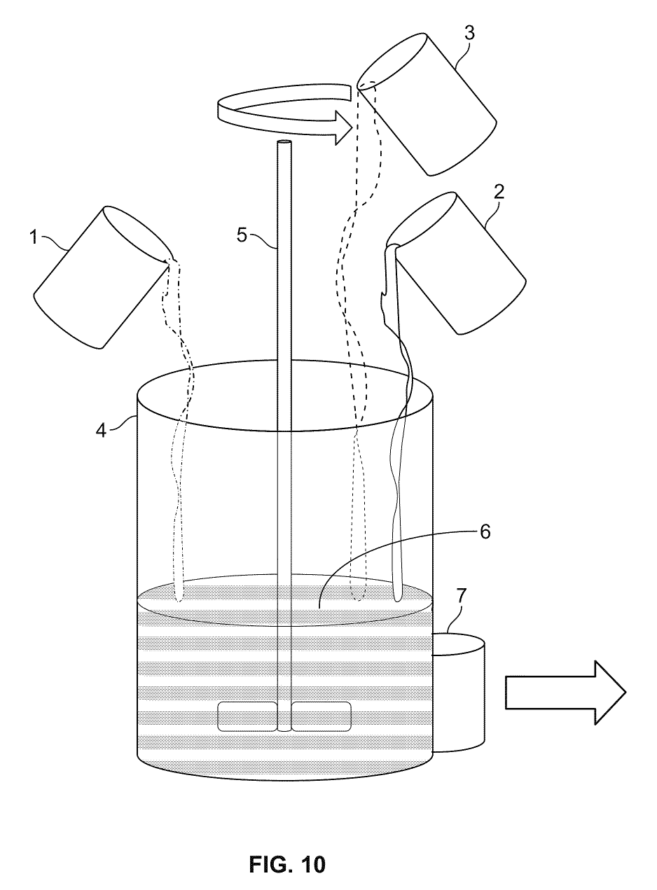

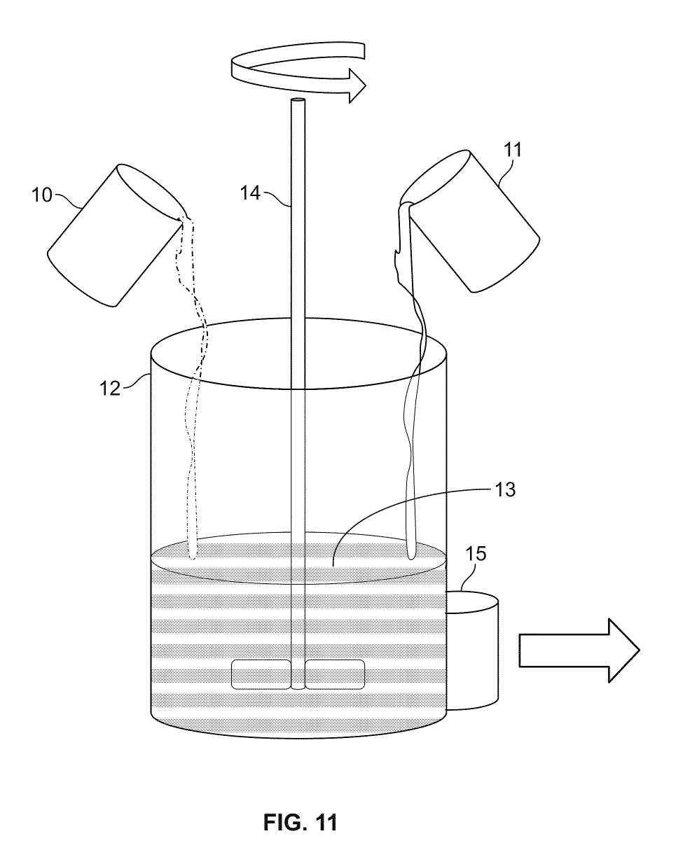

Incorporation of Na₂B₄O₇ into aluminum foam is accomplished by addition of the particulate into the foamable suspension used in its manufacture. In FIG. 10 a schematic diagram of apparatus for incorporating Na₂B₄O₇ into the manufacture of aluminum foam by addition of gas forming particles and anhydrous borax is shown. A liquid aluminum alloy feed system 1, a gas forming particulate feed system 2, and an anhydrous borax feed system 3 are used to supply materials to the reactor 4. A stirrer 5 is shown to facilitate the mixing of the three material streams. The foamable suspension 6 produced is then pumped from the reactor by means of a transport mechanism 7. In an alternative apparatus configuration shown in FIG. 11, a liquid aluminum alloy feed system 10 and a single feed system 11, containing a premixed blend of gas forming particulate and anhydrous borax in the proper ratio is used to supply materials to the reactor 12. A stirrer 14 is shown to facilitate the mixing of the two material streams. The foamable suspension 13 produced is then pumped from reactor by means of a transport mechanism 15.

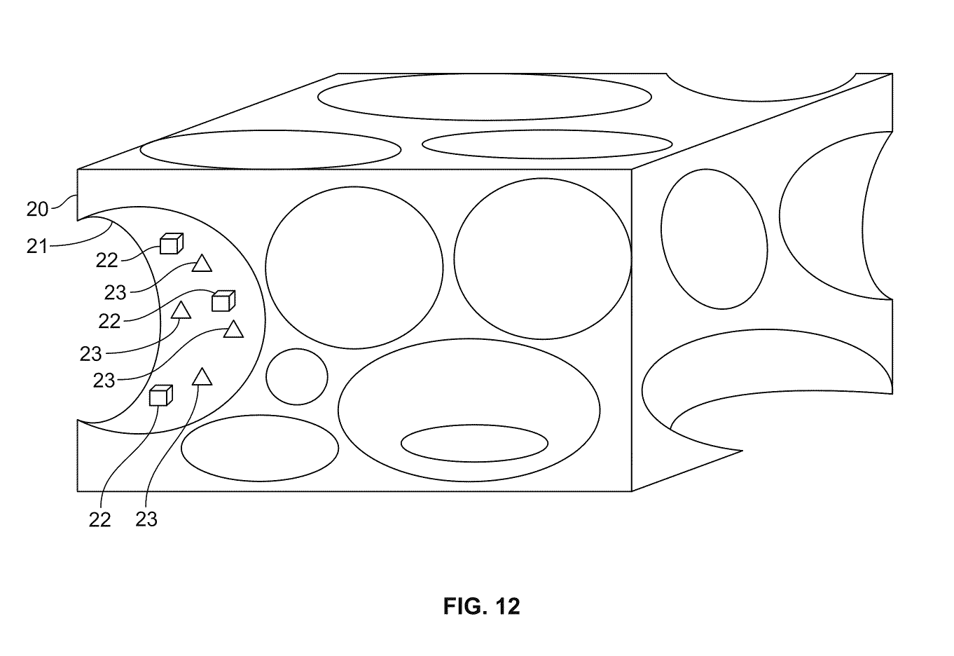

The product produced, as shown in the scanning electron micrograph in FIG. 9, is schematically shown in FIG. 12. In this FIG., an aluminum foam is drawn showing an aluminum alloy matrix 20 and cell walls 21. These cell walls are populated with both metal oxides 23 and a distribution of anhydrous borax particles 22. These anhydrous particles act to buffer any water that infiltrates to the exposed cell walls and thereby mitigate the dissolution of aluminum hydroxide and the associated corrosion reaction.

### Example 1

### Hydrogen Gas Generation in Laboratory Produced Aluminum Foam

Four samples of aluminum alloy of 97 grams each were prepared, each with a composition of an Al-2% Mg-1% Si, by weight. The four samples were melted and held at 670° C. Into these four molten aluminum alloy specimens were added 3 grams of CaCO₃ along with four different amounts of anhydrous borax, at addition levels of 0 grams, 0.25 grams, 0.5 grams and 1 gram. Each mixture was subjected to 2 minutes of vigorous stirring, and the specimens were allowed to foam at this temperature. No significant effects of the addition of anhydrous borax (Na₂B₄O₇) were seen in the foaming behavior.

Specimens were cut from the four test samples with anhydrous borax contents of 0%, 0.25%, 0.5% and 1.0% and each were tested for hydrogen gas generation when submerged in tap water. By determining the hydrogen gas content in a carrier gas of nitrogen, very exacting measures of corrosion reaction rates could be obtained using small specimens. In addition, the high sensitivity of the gas chromatography equipment allowed for measurements of the reaction rates even after very long times, when the rate of reaction had slowed to almost imperceptible levels.

To collect generated gases, foam specimens were dry cut to a thickness of 10 mm to expose all six surfaces and subjected to immersion tests. Specimens averaged 20 grams each for a total geometric surface area of approximately 52 cm² and a geometric volume of approximately 22 cm³, with two such specimens tested in each vessel. A carrier gas of nitrogen was bubbled into the vessel at a rate of 20 ml/min, and the gas was collected in a gas bag. The gasses produced were collected for up to 25 days. The dominant gas collected (other than the carrier gas, of course) was hydrogen, though small volumes of methane were also collected at roughly 0.5% of the measured hydrogen gas values.

The hydrogen gas generation rates and the cumulative hydrogen gas volumes over a 100 hour period are shown in FIGS. 3 and 4, respectively. As can be seen, the hydrogen gas generation rate drops significantly with increasing anhydrous borax additions. An addition of 1 wt % anhydrous borax effectively reduced the cumulative hydrogen gas generated by approximately 90%, and the rate of hydrogen gas evolution dropped to near zero following about 15 hours of immersion in water.

### Example 2

### Hydrogen Gas Generation in Plant Produced Aluminum Foam

A manufacturing trial was performed using a 1 wt % addition of Na₂B₄O₇ to aluminum foam. Twenty five kilograms of Dehybor® anhydrous borax was obtained from the 20 Mule Team division of Rio Tinto. The Dehybor® product in the Extra Fine particle size (99% 80 mesh; 92% 200 mesh) was used for this experiment. Based upon the laboratory tests, a 3:1 weight ratio of calcium carbonate to anhydrous borax was prepared. The dry powders were mixed in a single batch within a standard powder mixer and the mixture was added to the melt within the reactor following the standard operating method. The casting trial ran without incident and 20 standard panels of 2440 mm by 760 mm were produced.

Specimens of standard aluminum foam and aluminum foam inoculated with anhydrous borax were immersed in water and hydrogen gas was collected using the protocol developed for laboratory specimens. FIGS. 5 and 6 compare the hydrogen gas generation rate and the cumulative hydrogen gas generation over a 48 hour period for specimens that were immersed in water, and FIGS. 7 and 8 compare comparable specimens which were kept wetted in water.

The tests indicate that a 1% borax addition performed as well or better than the laboratory produced samples in suppressing hydrogen gas evolution. Maximum hydrogen gas generation rates were reduced by 90% to 95% as a result of borax inoculation of the material. Cumulative hydrogen gas generation amounts, over a 100 hour period, were reduced by a comparable value of 90%. The rate of hydrogen gas generation following 100 hours of exposure, in both wetted samples and immersed samples dropped to near zero.

What is claimed is:

1. An aluminum foam product comprising;
a distribution of pores within a metal alloy comprising aluminum; and
a distribution of sufficiently dispersed buffering agents.

2. The aluminum foam product of claim 1, wherein, when the aluminum foam product with sufficiently dispersed buffering agents is immersed in water, subsequent measurement of hydrogen gas generated from the aluminum foam with sufficiently dispersed buffering agents is no more than 10% of the measurement of hydrogen gas generated from aluminum foam lacking sufficiently dispersed buffering agents and immersed in water.

3. The aluminum foam product of claim 1 wherein the buffering agent is anhydrous borax.

4. The aluminum foam product of claim 1 wherein the buffering agent is boron oxide.

5. The aluminum foam product of claim 1 wherein the buffering agent is boric acid.

6. The aluminum foam product of claim 3 wherein the anhydrous borax constitutes from about 0.25 wt % to about 3 wt % of the metal alloy.

7. The aluminum foam product of claim 1 wherein the product comprises aluminum, magnesium, calcium carbonate and the products of their reaction together.

8. The aluminum foam of claim 1, wherein the product is in the form of a structural material.

9. The aluminum foam of claim 1 wherein said the product is a plate, sheet, extrusion or panel.

10. A method comprising the steps of;
a. adding gas producing particles to a molten metal alloy comprising aluminum;
b. adding buffering agents to said molten metal alloy;
c. agitating the molten metal alloy containing the buffering agents and the gas producing particles to produce a foamable suspension;
d. foaming the foamable suspension to produce a liquid metal foam; and
e. solidifying the liquid metal foam to produce a foamed aluminum product comprising sufficiently dispersed buffering agents.

11. The method of claim 10, wherein the gas producing particles and the buffering agents are combined prior to addition of the gas producing particles and the buffering agents to the molten metal alloy comprising aluminum.

12. The method of claim 10, wherein the buffering agent is anhydrous borax.

13. An apparatus comprising;
a feeding system for providing gas-producing particles;
a feeding system for providing buffering agents;
a feeding system for providing molten metal alloy comprising aluminum;
a reactor unit in communication with said feeding systems having a stirrer contained therein.

14. The apparatus of claim 13, wherein the feeding system for providing gas-producing particles and the feeding system for providing buffering agents are comprised of a single feeding system.
